(19) United States
(12) Patent Application Publication
(10) Pub. No.: US 2007/0235982 A1
(43) Pub. Date: Oct. 11, 2007

(54) ATV trailer hitch assembly

(76) Inventor: Bobby G. Cumbie, Newnan, GA (US)

Correspondence Address: GEORGE R. REARDON, 3356 STATION COURT, LAWRENCVILLE, GA, 30044, US

(21) Appl. No.: 11/354,791

(22) Filed: Feb. 15, 2006

(51) Int. Cl. B60D 1/40

(52) U.S. Cl. 280/478.1

(57) ABSTRACT

An ATV trailer hitch assembly is disclosed. The ATV trailer hitch assembly includes a tongue assembly and an adjustment assembly. The tongue assembly and adjustment assembly are operable for improved cornering and uneven terrain compensation for an ATV trailer using the ATV trailer hitch assembly.

### BACKGROUND OF THE INVENTION

The present invention relates generally to a trailer hitch assembly and more particularly to an All Terrain Vehicle (ATV) utility trailer hitch assembly with improved leveling characteristics.

ATVs equipped with a trailer are commonly used in hunting, farming, landscaping, gardening and the like. A plethora of trailer hitches have been designed for these and related trailers.

ATV trailers must be capable of successfully traversing a wide range of terrain, especially un-cleared land and the trailer hitch plays an important role in this successful traversing. ATV trailers are generally no wider than the towing ATV and both the trailer and the trailer hitch must be tough enough to take substantial abuse while carrying considerable loads of non-uniform size and weight over a variety of terrains.

The problem with conventional trailer hitches is that they are not designed to allow the trailer wheels to compensate for uneven terrain and to effectively track behind the ATV as it navigates around trees and bushes.

Examples of patents related to trailer hitches include the following:

U.S. Pat. No. 6,203,049, issued to David A. Gibson, on Mar. 20, 2001, discloses a terrain following hitch which mounts on a tractor draw bar by a pin, and which allows an implement being towed to move in three planes, independent of the tractor. The hitch includes three hinges, and a draw bar attachment tube which fits over the draw bar of a tractor, and transmits force to the walls of the draw bar, instead of into the pin and pin holes. The hitch reduces wear on implements and hitch connections.

U.S. Pat. No. 6,877,758, issued to Vincent Colistro, on Apr. 12, 2005, discloses a hitch extension apparatus for attaching an implement with a PTO driven drive shaft having front and rear universal joints to a tractor drawbar. The apparatus comprises a first member adapted for attachment to the tractor drawbar by insertion of a drawbar pin through the drawbar such that the first member is fixed with respect to the drawbar. An extension member is pivotally attached to the first member about a horizontal pitch axis oriented perpendicular to the travel direction, and about a horizontal roll axis oriented parallel to the operating travel direction. The extension member defines a pivotal attachment location rearward of the draw pin hole adapted for pivotal attachment of the implement about a vertical yaw axis located equidistant from the front and rear universal joints when the drive shaft is connected to the tractor power take off. The pitch axis can be located forward of the yaw axis, and forward of the draw pin hole in order to reduce bending forces on the drawbar.

U.S. Pat. No. 6,902,181, issued to Mark R. Kamunen, on Jun. 7, 2005, discloses a hitch device for use with a pulling vehicle and a trailer, including a first hitch arm and a second upwardly directed hitch arm. At a second end of the second upwardly directed hitch arm is a joint allowing rotation about at least two axes. The hitch device positions the joint a pre-selected vertical and horizontal distance from the pulling vehicle and a hitch receiving structure connected thereto. The hitch device may be used with a trailer having first and second diverters encouraging the trailer to move about a tree or other shrub.

U.S. Pat. No. 5,375,867, issued to John J. Kass, Philip K. Hoopes and Wayne E. Sousley, on Dec. 27, 1994, discloses a weight distributing hitch for towing a trailer behind a vehicle includes a hitch bar for mounting to the vehicle and a ball mount head for mounting on the hitch bar at a selected tilt angle. A pair of spring bars is mounted to the ball mount head. These spring bars distribute the weight of the trailer relative to the vehicle. Each spring bar is substantially L-shaped and includes a turned groove at a proximal end received in a cooperating aperture in the ball mount head. A retainer of spring steel engages in the grooves to hold the spring bars in position. The relative tilt angle of the ball mount head is adjusted by means of an eccentric angle adjusting element in the form of a washer. This washer is fixed to one of the ball mount head or hitch bar and includes a cam surface for engaging the other of the two elements. A method of adjusting the tilt angle is also provided.

U.S. Pat. No. 5,381,647, issued to Ronald D. Eberle, on Jan. 17, 1995, discloses an apparatus comprising a front mower driven by a self propelled all terrain vehicle to the rear of the mower and connected by an articulating hitch. The hitch includes a pair of spaced pivot mechanisms to allow the mower to pivot from front to rear relative to the all terrain vehicle and a third pivot mechanism to allow the mower to rotate about a horizontal axis from side to side such that the mower is driven by the all terrain vehicle, but is free to follow the contour of the ground being traversed by the apparatus independent of the all terrain vehicle.

U.S. Pat. No. 5,707,072, issued to Dennis D. Hopper, on Jan. 13, 1998, discloses a receiver hitch system for all-terrain sport vehicles includes a rigid mast assembly attaching to a two-point receiver hitch at the rear of the vehicle. A lower receiver hitch is attached to a non-suspended axle of the ATV, and an upper receiver hitch attaches to a suspended frame of the ATV, so that the rear suspension cannot operate, and loads on the mast assembly are borne directly by the axles and wheels. Lifting masts with booms, hunting platforms, and cargo boxes may be supported by the mast assembly.

U.S. Pat. No. 5,746,275, issued to Gary Cross and Ken Sloan, on May 5, 1998, discloses a three-point hitch for an ATV comprising a mounting frame which is attached to the axle housing of the ATV. The mounting frame is supported on the tongue hitch of the ATV and is attached to the body of the ATV so that the rear suspension of the ATV is locked-out. The multiple-point hitch is operatively secured to the mounting frame and is raised and lowered by means of an electromechanical screw actuator. The multiple-points of the hitch are free to float, in some situations, with respect to the mounting frame and the ATV.

U.S. Pat. No. 6,036,417, issued to Danny C. Weaver, on Mar. 14, 2000, discloses a stabilizing arm for stabilizing and securing an all-terrain vehicle in the bed of a pickup truck, which stabilizing arm includes in a preferred adjustable embodiment, a support typically selectively pivotally or rotatably and slidably disposed in a support sleeve mounted on a drawbar typically fitted to a conventional truck trailer hitch. A support arm projects from the top end of the support and terminates in a fixed or pivotable ball coupler designed to couple to an ATV ball attached to the all-terrain vehicle. In a preferred embodiment a clamp is threaded in the typically box tubing support sleeve and selectively engages the box tubing support for securing the support in non-sliding relationship with respect to the support sleeve. A cylindrical support leg is secured to the bottom end of the support to facilitate uncoupling the ball coupler from the ATV ball, lifting the support in the support sleeve upon loosening the clamp, aligning the cylindrical support leg with the support sleeve and pivoting or rotating and lowering the support and support arm into a position below the plane of the truck bed and allow loading and unloading the all-terrain vehicle. In a non-adjustable embodiment, the stabilizing arm includes a support, support arm and drawbar that are fixed with respect to each other.

U.S. Pat. No. 6,536,794, issued to Dennis H. Hancock and Jeffrey D. Hancock, on Mar. 25, 2003, discloses a tow hitch for all-terrain vehicles including an attachment leg with a hole therethrough for bolting of the attachment leg to a draw bar of the vehicle, a tow ball support leg with a pair of aligned, spaced apart holes adjacent to one end of the support leg and a tow ball having a threaded stem inserted through the one of said holes remote from the one end of the support leg to receive a nut thereon and structure to connect the attachment leg and the support leg in an offset relationship and with one structure connecting the attachment leg to the support leg comprising an insert box carried by the attachment leg and a box extension carried by the support leg and lockable into the insert box.

While these patents and other previous methods have attempted to solve the problem to which they were directed, none have employed a design that enables a combination of improved cornering and uneven terrain compensation.

Therefore, a need exists for an ATV trailer hitch assembly that is enabled for improved cornering and uneven terrain compensation of a trailer so equipped.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a new ATV trailer hitch with improved cornering and uneven terrain compensation. The present invention is intended to be used with trailer that is towed behind an ATV or similar method of transport. The present invention is comprised of a tongue assembly and an adjustment assembly.

The tongue assembly is comprised of an external tongue having two internal tongues inserted within a cavity in the external tongue. A threaded bolt is inserted within the two internal tongues and terminates with a zinc washer adjacent to a nut held with a cotter key that is inserted through a hole in the external tongue and emerges through a corresponding hole on the other side of the external tongue. A brass washer is on the thereafter bolt at the space between ends of the two internal tongues.

The adjustment assembly is comprised of a receiver insert tube, a height adjusting bracket, a receiver mounting bracket, bolts with lock nuts, and holes for the bolts with lock nuts.

One advantage of the present invention is to provide a device that enables a trailer corner closely with an ATV when going around trees and bushes.

Another advantage of the present invention is to provide a device that can be used with an ATV trailer that is cost effective.

Another advantage of the present invention is to provide a device that can be used with an ATV trailer that is easy to use.

Another advantage of the present invention is to provide a device that can be used with an ATV trailer that can be reused many times.

Another advantage of the present invention is to provide an assembly process for making the invention which uses readily available materials and components.

Another advantage of the present invention is to provide a method for using the invention that is easy to learn.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

The basis for the present invention is centered on a hitch for a trailer used behind an ATV.

The disclosed trailer hitch assembly pertains to use with all-terrain-vehicles. The trailer hitch assembly includes features which allow a trailer to track closely with the ATV as it goes around trees, bushes and large rocks. The trailer hitch assembly also includes features which allow a trailer to adjust quickly to differences in terrain underneath the right side and left side of a trailer.

There has thus been outlined, rather broadly, the more important features and benefits of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The accompanying drawings illustrate a complete embodiment of the invention according to the best modes so far devised for the practical application of the principles thereof, and in which:

FIG. 1 is a perspective view of an ATV trailer hitch assembly according to an embodiment of the invention.

FIG. 2 is a left side plan view of an ATV trailer hitch assembly in an extended position according to an embodiment of the invention.

FIG. 3 is a top plan view of an ATV trailer hitch assembly in a non-extended position according to an embodiment of the invention.

FIG. 4 is a bottom plan view of an ATV trailer hitch assembly according to an embodiment of the invention.

FIG. 5 is a plan view of a portion of an ATV trailer hitch assembly according to an embodiment of the invention.

FIG. 6 is a left side plan view of the adjustment assembly portion of an ATV trailer hitch assembly according to an embodiment of the invention.

FIG. 7 is a top plan view of a portion of an ATV trailer hitch assembly according to an embodiment of the invention.

FIG. 8 is a right side plan view of the adjustment assembly portion of an ATV trailer hitch assembly according to an embodiment of the invention.

FIG. 9 is a partial plan view of a portion of an ATV trailer hitch assembly according to an embodiment of the invention.

FIG. 10 is a rear plan view of an ATV trailer hitch assembly according to an embodiment of the invention.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

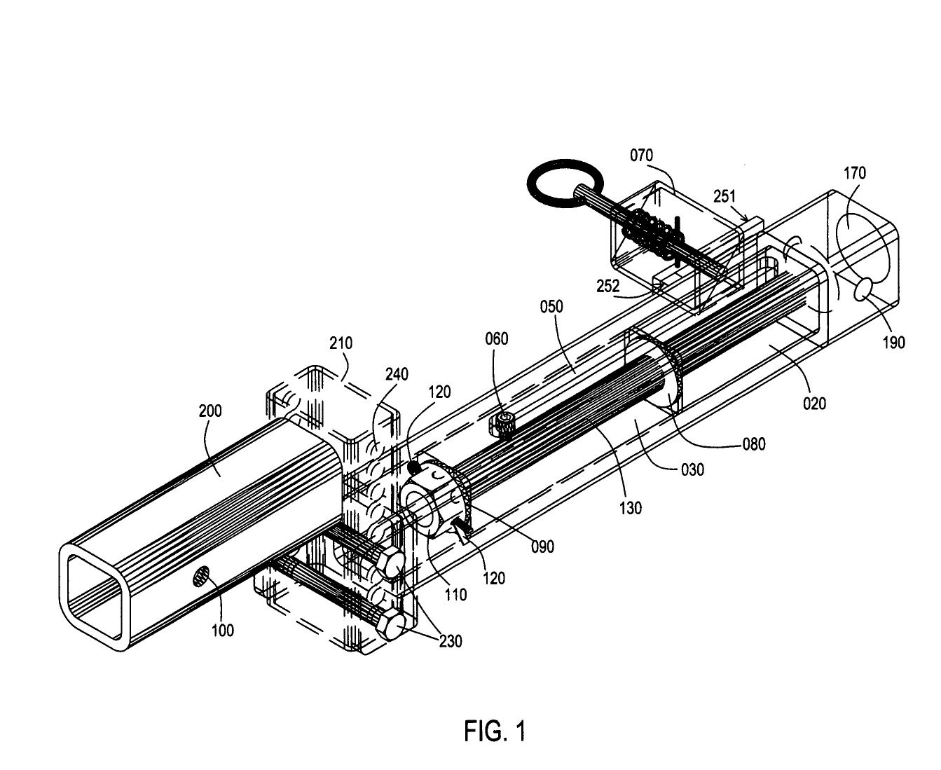

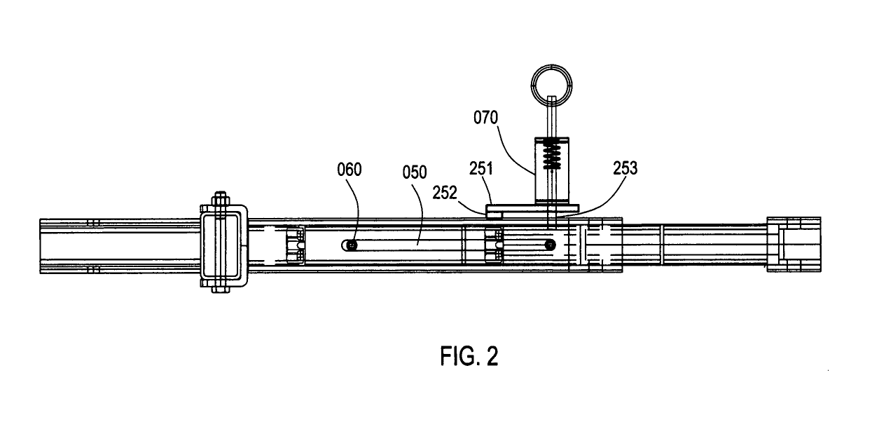

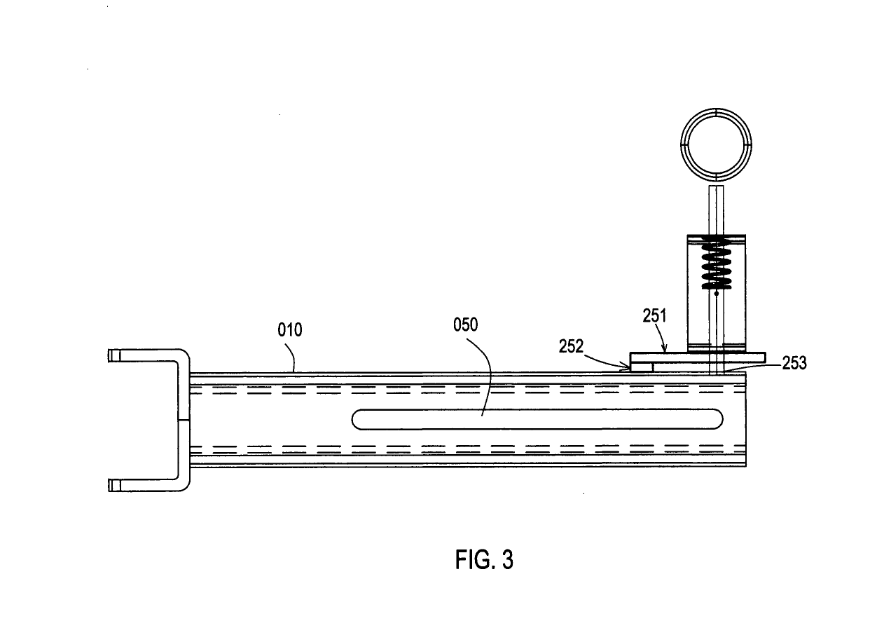

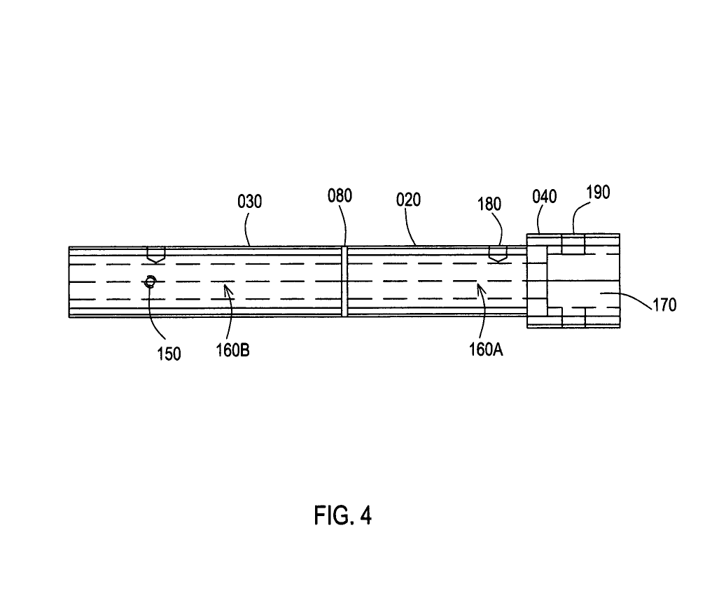

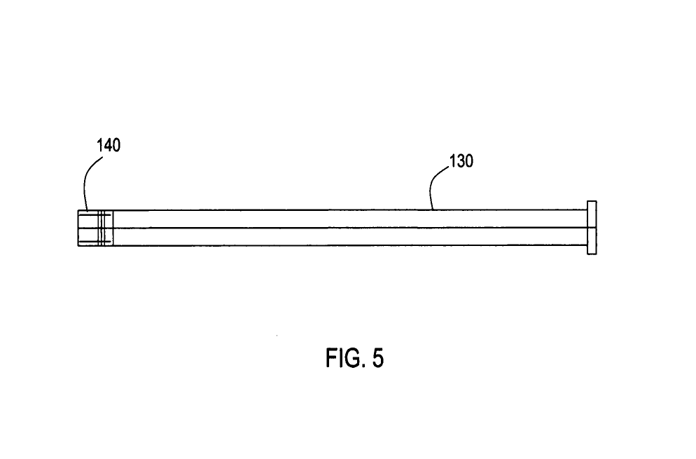

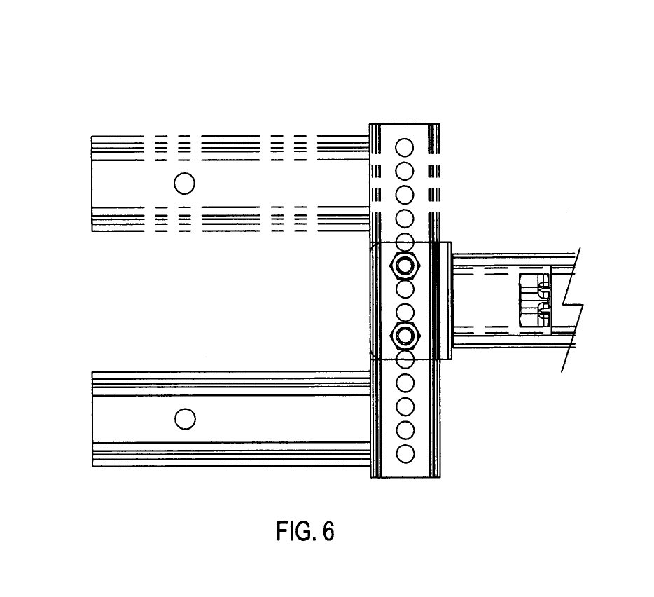

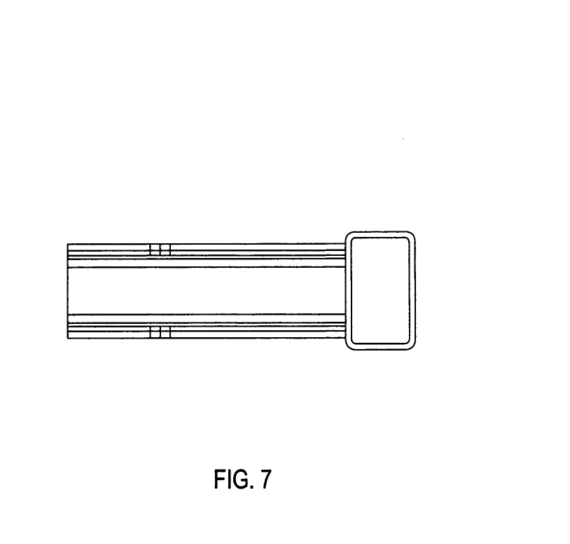

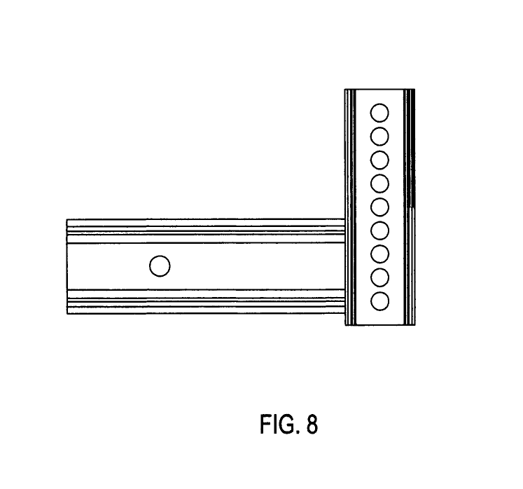

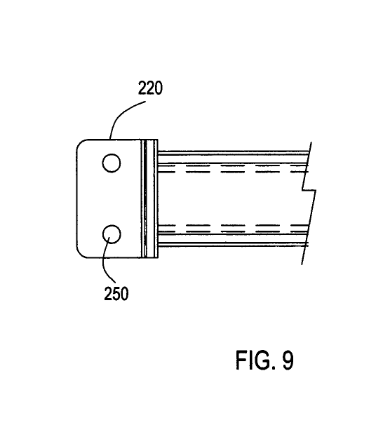

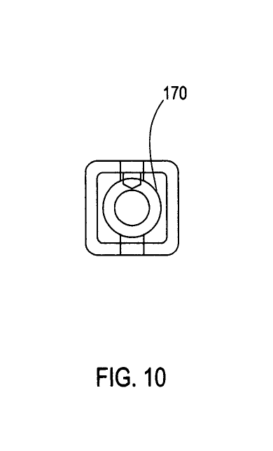

Referring now to FIG. 1 through FIG. 10, a preferred embodiment of the present invention is illustrated. The present invention is comprised of a tongue assembly and an adjustment assembly.

The tongue assembly is comprised of external tongue 010, internal tongue-A 020, internal tongue-B 030, collar 040, slot 050, cap screw 060, spring locking pin 070, brass washer 080, zinc washer 090 nut 110, cotter key 120, bolt 130, first hole 140, tap 150, second hole 160, bore 170, third hole 180, fourth hole 190, spring locking pin bracket spacer 251, spring locking pin mounting plate 252 and eighth hole 253.

The adjustment assembly is comprised of receiver insert tube 200, height adjusting bracket 210, receiver mounting bracket 220, bolts with lock nuts 230, fifth hole 240, sixth hole 250 and seventh hole 100.

The preferred embodiment of the invention is made as follows:
1. Weld external tongue 010 to receiver mounting bracket 220
2. Drill second hole-A 160-A all the way through internal tongue-A 020
3. Drill second hole-B 160-B all the way through internal tongue-B 030
4. Create bore 170 in Collar 040
5. Weld Collar 040 to internal tongue-A 020
6. Mill slot 050 slot to proper length in external tongue 010
7. Install tap 150 into internal tongue-B 030
8. Thread cap screw 060 into 030 and travels in slot 050
9. Insert bolt 130 in internal tongue-A 020
10. Install brass washer 080 on bolt 130
11. Insert bolt 130 in internal tongue-B 030
12. Create seventh hold 100 in receiver insert tube 200
13. Drill first hole 140 through bolt 130
14. Install zinc washer 090 onto bolt 130
15. Threat nut 110 onto bolt 130
16. Install cotter key 120 through nut 110 and bolt 130
17. Drill third hole 180 hole for spring locking pin 070
18. Fourth hole 190 attaches to the ATV trailer bed by means of bolt, nut and washer
19. Weld receiver insert tub 200 to receiver mounting bracket 220
20. Install fifth hole 240 into height adjusting bracket 210
21. Install bolts with lock nuts 230 into receiver mounting bracket 220 and fifth hole 240
22. Install sixth hole 250 into receiver mounting bracket 220
23. Weld spring locking pin bracket spacer 251 to external tongue 010
24. Weld spring locking pin mounting plate 252 to spring locking pin bracket spacer 251
25. Weld spring locking pin 070 to spring locking pin mounting plate 252.

The preferred method of using this embodiment of the invention is comprised of the following steps.
1. Install fourth hole 190 to an ATV trailer bed by means of at least one bolt, nut and washer
2. Insert receiver insert tube 200 in ATV Receiver
3. Install ⅝′ bolt and pin provided with ATV
4. Pull spring locking pin 070
5. Telescope tongue assembly out.
6. Release spring locking pin 070
7. To adjust the proper height, remove bolts with lock nuts 230
8. Adjust to proper height.
9. Re-install bolts with lock nuts 230
10. If further height adjustment is needed, remove bolts with lock nuts 230
11. Lay tongue assembly down.
12. Remove receiver insert tube 200 from ATV receiver by removing ⅝′ bolt and retainer pin.
13. After removing, rotate receiver insert tube 200 180 degrees.
14. Re-install receiver insert tube 200 into receiver of ATV with ⅝′ bolt and retainer pin.
15. Re-install tongue assembly to proper height with bolts with lock nuts 230. The ATV trailer is now ready for use.
16. The ATV trailer in a store position, pull spring locking pin 070
17. Telescope tongue assembly all the way in.
18. Raise trailer up approximately 90 degrees.
19. Release spring locking pin 070. The ATV trailer is now in the store position.

The parts for the preferred embodiment of the invention are as follows:

| PART | | PREFERRED |
|---|---|---|
| NUMBER | PART NAME | SPECIFICATIONS |
| 010 | External Tongue | 2″ × 2″ × ¼″ square tubing |
| 020 | Internal Tongue-A | 1½″ × 1½″ square tubing |
| | | with ¾″ hole |
| 030 | Internal Tongue-B | 1½″ × 1½″ square tubing |
| | | with ¾″ hole |
| 040 | Collar | 2″ × 2″ × ¼″ square tubing |
| 050 | Slot | ¼″ × ⅜″ × 8″ |
| 060 | Cap Screw | ¼″ - 20 hexagon socket |
| | | head cap screw |
| 070 | Spring Locking Pin | ⅜″ |
| 080 | Brass Washer | 1½″ × ⅛″ × ¾″ ID |
| 090 | Zinc Washer | 1½″ × ⅛″ × ¾″ ID |
| 100 | Seventh Hole | ⅝″ |
| 110 | Nut | ¾″ - 18 slotted hex nut |
| 120 | Cotter Key | ⅛″ × 1½″ cotter key |
| 130 | Bolt | ¾″ - 18 Threaded |
| 140 | First Hole | ⅛″ Threaded |
| 150 | Tap | Drill & Tap ¼″ - 20 × ⅜″ |
| | | deep |
| 160 | Second Hole | ¾″ |
| 170 | Bore | 1/¼″ diameter bore |
| | | 1½″ deep |
| 180 | Third Hole | ⅜″ |
| 190 | Fourth Hole | ½″ |
| 200 | Receiver Insert Tube | 2″ × 2″ × ¼″ square tubing |
| 210 | Height Adjusting Bracket | 2″ × 1½″ × ⅛″ rectangular |
| | | tube |
| 220 | Receiver Mounting Bracket | 2¾″ × 1¾″ × ¼″ channel |
| 230 | Bolts With Lock Nuts | ⅜″ - 16 × 3½″ bolt with |
| | | lock nut |
| 240 | Fifth Hole | ⅜″ thru hole |
| 250 | Sixth Hole | ⅜″ thru hole |
| 251 | Spring Locking Pin Bracket | ¼″ × 1½″ × 1½″ flat bar |
| | Spacer | |
| 252 | Spring Locking Pin | ¼″ × 1½″ × 3″ flat bar |
| | Mounting Plate | |
| 253 | Eighth Hole | ⅝″ Thru Hole |

What is claimed is:

1. An ATV utility trailer hitch assembly comprising:
a) means for uneven terrain compensation, and
b) means for height adjustment, wherein said means for uneven terrain compensation is coupled to said means for height adjustment.

2. The ATV utility trailer hitch assembly of claim 1, wherein said means for uneven terrain compensation is comprised of a tongue assembly disposed with at least two internal tongues slideably connected and operable for uneven terrain adjustment.

3. The ATV utility trailer hitch assembly of claim 2, wherein said means for height adjustment is comprised of an adjustment assembly comprised of a receiver insert tube, a height adjusting bracket, and a receiver mounting bracket bolts, wherein said receiver insert tube, said height adjusting bracket and said receiver mounting bracket bolts are operably connected.
